(19) United States
(12) Patent Application Publication
(10) Pub. No.: US 2003/0215615 A1
(43) Pub. Date: Nov. 20, 2003

(54) Environmental protection floor tile

(76) Inventor: Chen-Chi Mao, Taipei (TW)

Correspondence Address: BACON & THOMAS, PLLC, 625 SLATERS LANE, FOURTH FLOOR, ALEXANDRIA, VA, 22314

(21) Appl. No.: 10/145,741

(22) Filed: May 16, 2002

(51) Int. Cl. B32B 3/00

(52) U.S. Cl. 428/195.1; 428/212

(57) ABSTRACT

An environmental protection floor tile, more specifically to a floor tile made of a material not containing chlorine, which comprising a printing layer and a bottom layer. The present invention is characterized that the printing layer is composed of two transparent layers of an upper layer and a lower layer, wherein the upper transparent layer has the features for wear-resisting and easy cleaning and the lower transparent layer has the features for easy color printing; and, the embossment and color of the floor tile is printed at the bottom on the lower transparent layer.

### BACKGROUND OF THE INVENTION

1. Field of the Invention

The present invention is a floor tile made of a material not containing chlorine, which is characterized that the printing layer is composed of two transparent layers, wherein the upper layer is formed as a layer with wear-resisting and easy cleaning and the lower layer is an easy-printing layer.

2. Prior art

The plastic product is a by-product from the development of oil energy resources that the development changes the only dependence to wood, metal material by the people from thousands of years so as to create a splendid plastic era. The plastic has brought for the people of convenience for light-weighted and easy manufacturing, however, the waste or the pollution during manufacturing causes a very annoying feeling to the people. Taken the plastic floor tile in plastic product as an example, the conventional plastic floor tile contained asbestos material so that the air pollution resulting from the manufacturing endangered the people's health. Afterwards, the polyvinyl chloride (PVC) was used to produce the plastic floor tile, which reduced the danger to the people's health but induced another problem. For a long time, the holes in the ozone layer above the South Pole are enlarged year by year so that the ultraviolet ray may intrude the earth without any shields and causing the greenhouse effect. The reason is that the chlorine element and the other composite using the same, such as a Fluor-chlorine carbide. Currently, the most dominant material in the plastic product is PVC, which is a composite made of chlorine element. Thus, the damage to the environment is very critical and unknown to the people.

The scientific field had noticed the damage to the environment by the PVC and found the solution, that is, using a composite not containing chlorine to manufacture the plastic product. But the composite not containing chlorine is very expensive. As an example for the plastic floor tile, the cost may be several tens to hundreds times over the conventional PVC floor tile. Thus, even the chlorine element in the PVC will damage the environment, there are not lots of plastic floor tile product not containing chlorine in the market under economical consideration. There is another question to be considered for the plastic floor tile made of a composite not containing chlorine, that is to achieve the normally wear-resisting effect for the plastic floor tile, wherein the printing layer on the surface is thicker and the embossment is printed at the bottom of the surface so that the embossment will never be taken off. However, such a technique will cause some problems while applying to the plastic floor tile not containing chlorine. Because the effect by the thickening caused higher cost, the floor tile originally in higher price will be more expensive.

### SUMMARY OF THE INVENTION

In order to realize a mass production for the plastic floor tile not containing chlorine, the inventor discloses a type of new plastic floor tile structure which has a printing layer and a bottom layer, wherein the two layers are adhered with each other and made of a material not containing chlorine. In which, the printing layer comprises the two upper and lower transparent layers that the upper transparent layer is provided with an excellent wear-resisting property so as to provide the wear-resisting effect for the floor tile. The upper transparent layer is also provided with the function for easy cleaning. The lower transparent layer is provided with the function for easy color printing that the embossment and the color of the floor tile can be printed at the bottom of the lower transparent layer. According to the characteristics of the plastic tile produced with a composite not containing chlorine, the processing for the wear-resisting function is the largest portion in the cost and other functions are in lower cost, such as printing or forming the bottom. Therefore, the present invention can make the depth as thinner as possible for the upper wear-resisting transparent layer and increase the depth of the lower transparent layer correspondingly so as to obtain a more economical structure. The design for the composite printing layer according to the present invention has proven to effectively reduce the cost for the manufacturing of plastic floor tile made of a material not containing chlorine and achieve the object for mass production.

### BRIEF DESCRIPTION OF THE DRAWINGS

FIG. 1 is a cross-sectional view in the present invention;

FIG. 2 is a locally enlarged view of FIG. 1;

FIG. 3 is a locally enlarged view of another embodiment of FIG. 1.

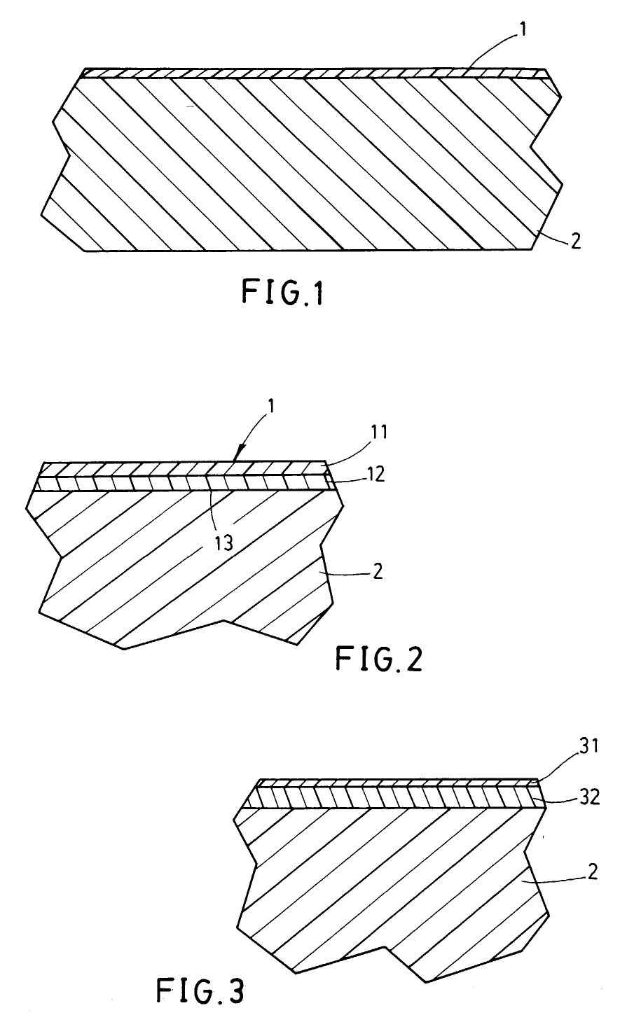

### DESCRIPTION OF PREFERRED EMBODIMENTS

The plastic floor tile according to the present invention comprises an upper printing layer 1 and a lower bottom layer 2 that the both are made of a material not containing chlorine, wherein the printing layer 1 actually further comprises an upper transparent layer 11 and a lower transparent layer 12. As show in FIG. 2, the depth of the upper transparent layer 11 is the same to that of the lower transparent layer 12, wherein the upper transparent layer 11 is provided with the features for wear-resisting and easy cleaning and the lower transparent layer 12 is provided with the feature for easy color printing, and the bottom 13 of the lower transparent layer 12 is provided with a printed embossment and color. A further embodiment according to the present invention is shown in FIG. 3, wherein the printing layer 3 also comprises an upper transparent layer 31 and a lower transparent layer 32, in which the upper transparent layer 31 is a layer for wear-resisting and easy cleaning, the lower transparent layer 32 is a layer with printed patterns, and the depth of the upper transparent layer 31 is thinner than that of the lower transparent layer 2.

What is claimed is:

1. An environmental protection floor tile, particularly a plastic floor tile made of a material not containing chlorine, which comprises a printing layer on the upper layer and a bottom layer on the lower layer and the both are adhered with each other, is characterized that a printing layer, further comprising an upper transparent layer and a lower transparent layer which are adhered with each other and the bottom of the lower transparent layer is printed with patterns.

2. An environmental protection floor tile as set forth in claim 1, wherein the upper transparent layer and the lower transparent layer are of the same depth.

3. An environmental protection floor tile as set forth in claim 1, wherein the depth of the upper transparent layer is thinner than that of the lower transparent layer.

4. An environmental protection floor tile as set forth in claim 1, wherein the upper transparent layer is the wear-resisting layer.
